(19) United States
(12) Patent Application Publication
(10) Pub. No.: US 2005/0233111 A1
(43) Pub. Date: Oct. 20, 2005

(54) Support as or for a paper machine clothing

(76) Inventor: Walter Best, Duren (DE)

Correspondence Address: BERENATO, WHITE & STAVISH, LLC, 6550 ROCK SPRING DRIVE, SUITE 240, BETHESDA, MD, 20817, US

(21) Appl. No.: 10/922,161

(22) Filed: Aug. 20, 2004

(30) Foreign Application Priority Data
Aug. 21, 2003 (EP) 03 019 005.2

(51) Int. Cl. B32B 3/10

(52) U.S. Cl. 428/131

(57) ABSTRACT

A liquid-permeable support for a paper machine clothing that is usable in the press section of a paper machine includes a support having at least two plies that brace against one another via discrete bracing elements. At the points where the plies brace against one another, there is applied on one or both sides an elastic coating which is embodied elastically in such a way that the spacing of the plies under pressure loading is decreased by elastic compression of the coating. Upon pressure relief the spacing is increased again by elastic recovery of the coating.

### CROSS-REFERENCE TO RELATED APPLICATIONS AND CLAIM TO PRIORITY

This application claims priority pursuant to 35 U.S.C. § 119 to application number 03 019 005.2, filed Aug. 21, 2003, with the European Patent Office, the disclosure of which is incorporated herein by reference.

### FIELD OF THE INVENTION

The invention concerns a liquid-permeable support as or for a paper machine clothing that is usable in the press section of a paper machine, the support having at least two plies that brace against one another via discrete bracing elements.

### BACKGROUND OF THE INVENTION

Paper machine clothings that are suitable for guiding the paper web through the press section of a paper machine are conventionally embodied as press felts. Such press felts have a support made up of a woven or knitted fabric or a yarn layer, onto which a nonwoven fabric is needle-felted so that the clothing has a felt-like character. Proposals have recently been made to replace the press felts with a paper machine clothing that is assembled from two (or more) extruded webs laid on top of one another, the webs bracing against one another via discrete bracing elements of a wide variety of conformations (cf. EP 0 802 280 A2; WO 01/98580). The bracing elements are also configured during the extrusion process. They are shaped in such a way that they engage into and fit behind one another. They determine the spacing between the two webs. The webs themselves are of porous configuration, so that the liquid pressed out of the paper web in the press can pass through the webs and the paper web is thereby dewatered. Nonwoven layers that are joined to the webs can be applied onto the outer sides of the two webs. In this case the structure made up of the webs and bracing elements forms a support for the nonwoven layers.

Such paper machine clothings have the property that they initially dewater the paper web very well in the front part of the press nip. In the rear part of the press nip, however, a re-wetting of paper web occurs because of the press pressure that continuously or suddenly weakens there, i.e. water flows back into the paper web out of the support and the paper-side nonwoven fabric. The dewatering performance of the paper machine clothing is thereby considerably reduced.

It is the object of the invention to configure a support of the kind cited initially in such a way that re-wetting of the paper web in the rear portion of the press nip is substantially lowered or in fact entirely avoided.

### SUMMARY OF THE INVENTION

This object is achieved, according to the present invention, in that at the points where the plies brace against one another, there is applied on one or both sides an elastic coating which is embodied elastically in such a way that the spacing of the plies under pressure loading is decreased by elastic compression of the coating, and upon pressure relief is increased again by elastic recovery of the coating. When a support embodied in this fashion is placed under pressure in the press, the result is a reduction in the thickness of the support and thus a decrease in the open volume between the two plies. The pressure weakens in the rear part of the press nip, and the spacing between the plies instantaneously recovers elastically to the initial state. The water-filled open volumes between the plies are thereby enlarged, thereby creating a water-free space in the region of the paper-web-side ply that delays the return flow of water, and in fact draws water out of the paper-side nonwoven fabric into the support, until the paper web has been separated from the paper machine clothing. The speed of the recovery process after leaving the press nip can be controlled by adjusting the elasticity so that the most optimum possible effect occurs. The coating can be made of rubber, polyurethane, or another elastomer, for example a silicone elastomer.

The plies and bracing elements are advantageously shaped so that they can be manufactured from plastic as extruded webs. Suitable plastics are principally polyamide-6, -6,6, -6,10, -6,12, or -12, or PTT, but also other plastics such as those set forth, for example, in claims 16 through 23 of WO 01/98580 A1.

In order for the support to be liquid-permeable, it should be provided with a grid of perforations that can be produced, for example, using a laser. The permeability can be adapted individually to the particular circumstances by way of the size and the number of the perforations per unit area.

The bracing elements are advantageously embodied in such a way that they fit one behind another, so that joining of the layers is accomplished via the bracing elements themselves. The bracing elements can be embodied in mirror-image fashion but arranged with an offset from each other. To allow them to be shaped along with the respective web by extrusion, the bracing elements should be embodied as bracing struts extending in the longitudinal direction, i.e. the extrusion direction, of the support.

The bracing elements can be curved at their free ends. A mushroom-like or arrow-like cross section is particularly useful, since struts that can fit behind one another are thereby constituted.

Provision is further made according to the invention for the bracing elements to comprise a notch that advantageously is filled with the material of the elastic coating. It can furthermore be useful if the bracing elements have differing spacings.

### DESCRIPTION OF THE DRAWINGS

FIG. 1 is a fragmentary cross-sectional view of a support for a paper machine clothing according to the invention

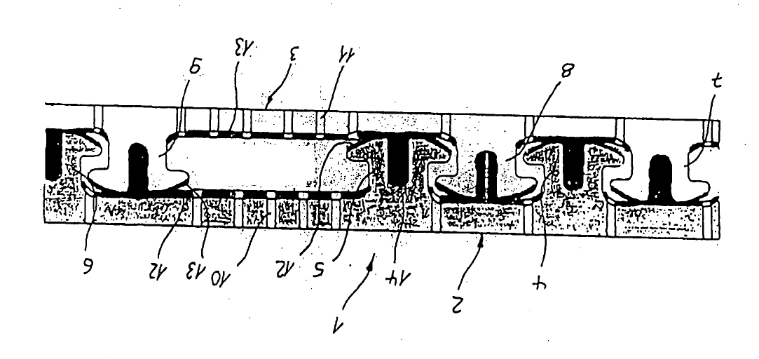

### DETAILED DESCRIPTION OF THE PREFERRED EMBODIMENT(S)

The invention is illustrated in more detail, with reference to an exemplary embodiment, in the drawing, which shows a partial cross section through a support 1 for a paper machine clothing that is to be used in the press section of a paper machine. Support 1 comprises two extruded webs 2, 3 that are embodied in mirror-image fashion. Webs 2, 3 comprise bracing struts 4, 5, 6 and 7, 8, 9, mushroom-shaped in cross section, that extend perpendicular to the drawing plane and thus in the extrusion direction. They are arranged so that they fit behind one another with their lateral projections after having previously been clipped together.

Both webs 2, 3 comprise perforations (labeled 10, 11 by way of example), i.e. are liquid-permeable. Support 1 is therefore suitable for dewatering a paper web.

The mutually facing sides of webs 2, 3 and of bracing struts 4, 5, 6, 7, 8, 9 are each provided with a coating 12, 13 (depicted continuously in black) that is made of rubber or an elastomer. The material of coatings 12, 13 projects into blind holes (labeled 14 by way of example) that are shaped into bracing struts 4, 5, 6, 7, 8, 9.

Non-woven layers can be applied onto the externally located upper and lower sides of support 1 and attached, for example, using adhesive.

The travel direction of a support 1 of this kind extends perpendicular to the drawing plane. Upon passage through the press section of a paper machine, bracing struts 4, 5, 6, 7, 8, 9 initially rest with no great pressure against the respectively opposite web 2, 3, and its coating 12, 13. Upon passage through the press nip, the pressure rises, so that coatings 10, 11 in the region of bracing struts 4, 5, 6, 7, 8, 9 are elastically compressed so that the overall thickness of support 1 decreases correspondingly. After the press nip, a recovery occurs into the initial position because of the spring effect of coatings 12, 13. The open volume between the two webs 2, 3 is thereby abruptly increased, with the consequence that liquid is drawn back into perforations 12, 13 into the open interior. With appropriate adjustment of the elasticity of coatings 12, 13, this effect occurs so quickly that water flows back into the open volume between webs 2, 3 and is retained until the paper web has lifted away from support 1. As a result, any re-wetting of the paper web is minimized and the overall degree of dewatering is thus increased.

1. A liquid-permeable support (1) as or for a paper machine clothing that is usable in the press section of a paper machine, the support (1) having at least two plies (2, 3) that brace against one another via discrete bracing elements (4 through 9),
wherein at the points where the plies (2, 3) brace against one another, there is applied on one or both sides an elastic coating (12, 13) which is embodied elastically in such a way that the spacing of the plies (2, 3) under pressure loading is decreased by elastic compression of the coating (12, 13), and upon pressure relief is increased again by elastic recovery of the coating (12, 13).

2. The support as defined in claim 1, wherein the coating is made of rubber or an elastomer.

3. The support as defined in claim 1, wherein the plies (2, 3) and bracing elements (4 through 9) are constituted from extruded webs.

4. The support as defined in claim 1, wherein the plies (2, 3) are made of polyamide-6, -6,6, -6,10, -6,12, or -12, and PTT.

5. The support as defined in claim 1, wherein the plies (2, 3) are perforated.

6. The support as defined in claim 1, wherein the bracing elements (4 through 9) fit one behind another.

7. The support as defined in claim 1, wherein the bracing elements (4 through 9) are embodied in mirror-image fashion but arranged with an offset from each other.

8. The support as defined in claim 1, wherein the bracing elements are embodied as bracing struts (4, 9) extending in the longitudinal direction of the support.

9. The support as defined in claim 1, wherein the bracing elements (4 through 9) are curved at their free ends.

10. The support as defined in claim 1, wherein the bracing elements (4 through 9) have a mushroom-like or arrow-like cross section.

11. The support as defined in claim 1, wherein the bracing elements (4, 9) comprise a notch (14).

12. The support as defined in claim 11, wherein the notches (14) are filled with the material of the elastic coating (12, 13).

13. The support as defined in claim 1, wherein the bracing elements (4, 9) have differing spacings.
